(19) United States
(12) Patent Application Publication
(10) Pub. No.: US 2010/0088021 A1
(43) Pub. Date: Apr. 8, 2010

(54) COLLECTION METHODS AND DEVICES

(76) Inventors: Marcus Rishi Leonard Viner, Victoria (AU); Derek Basil Leonard Viner, Victoria (AU)

Correspondence Address: EDWIN D. SCHINDLER, FIVE HIRSCH AVENUE, P.O. BOX 966, CORAM, NY, 11727-0966, US

(21) Appl. No.: 12/597,541

(22) PCT Filed: Apr. 24, 2008
(86) PCT No.: PCT/AU08/00568

§ 371 Date: Nov. 4, 2009

(30) Foreign Application Priority Data
Apr. 26, 2007 (AU) 2007902187

(51) Int. Cl. G01C 21/36; G06F 15/16

(52) U.S. Cl. 701/201; 709/201

(57) ABSTRACT

A method for collecting data includes the steps of equipping vehicles in a fleet of vehicles, performing a primary service, with imaging equipment and capturing geographical data using the imaging equipment for later use in a store of geographical data.

### FIELD OF INVENTION

The present invention relates to image collection including transport route image collection methods and devices. In one arrangement there is provided a method of collecting geographical data. The geographical data preferably includes asset information including the condition of roads, kerbs and gutters and footpaths.

### BACKGROUND ART

In the field of transport route image collection there are several problems including the inability of local government councils to access up to date data associated with services provided to their electorate. These services include the provision of road networks, bicycle paths and foot paths.

Councils sometimes employ specialist vehicles and crews to monitor bitumen and other aspects of road quality. The data provided by these specialist vehicles and crews is typically expensive to produce and maintain. In addition, the data provided is often incomplete and accessible only by particular individuals.

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

It is an object of the embodiments described herein to overcome or alleviate at least one of the above noted drawbacks of related art systems or to at least provide a useful alternative to related art systems.

### SUMMARY OF INVENTION

According to a first aspect of arrangements described herein there is provided a method of collecting data comprising: equipping vehicles in a fleet of vehicles performing a primary service, with imaging equipment; capturing geographical data using the imaging equipment for later use in a store of geographical data.

Preferably the vehicles comprise service vehicles and the primary service depends on the purpose of these vehicles. The primary service may include transport of paying passengers, transport of tradesmen, movement of service vehicles and similar. For example the vehicles may comprise taxis with the primary service being a transport service in which passengers are conveyed between locations of their choice.

In arrangements the geographic information may includes asset information associated with road or road-side assets distributed over a road network and be captured when at least one of the vehicles is in an area of interest. Other types of routes include trains, trams, and waterways over which asset information is collated.

According to a second aspect of arrangements described herein there is provided a system for collecting data comprising: a transmission facility for transmitting network information to a plurality of vehicles in a fleet of vehicles performing a primary service thereby facilitating the capture of geographical data using the network information.

In preferred arrangements the organisation implementing the invention, the Operating Organisation, establishes a mutually beneficial relationship with an organisation whose vehicles are already operating on the route network of interest. For example:

i. Taxis driving the roads of a population area

ii. Vans driving the roads of a population area

iii. Trucks driving state highways

iv. Locomotives travelling on rail networks

v. Ships travelling on waterways and shipping routes

vi. Trams travelling on tracks.

A route network consists of segments, being the length of route from one point to another and nodes, being the points on the route where two segments intersect or where a segment intersects some other feature of interest or terminates. A segment or link is the length of route between two nodes. Segments are sometimes called links. Other definitions are possible.

Preferably the Operating Organisation makes available Remote Automated Collection Units (RACU) that are located on the vehicles in a suitable location, for example the roof, and Host Vehicle Interfaces that are located in the control cabin, for example, of the vehicle. This arrangement can be through lease or sale or other commercial means.

Each RACU may consist of a number of imaging devices, for example multiple cameras forming a camera array. The RACU's may include a navigation unit that includes for example geographic positioning system, magnetic and inertial capability, a data storage, a communication capability, power supply and a central processing unit.

The Operating Organisation preferably markets services to users of images and the data that may be derived from them, for example the nature and condition of route-side assets.

The Operating Organisation may develop a route segment listing that contains route node location and segment length information for the route networks of interest to it and its clients.

In one arrangement the host vehicles travel the network going about their normal business. When their route coincides with a route segment for which imaging is needed the RACU automatically collects the images. The host vehicle operator is able to see nearby route segments that are in need of imaging through the display on the Host Vehicle Interface. The operator may make the decision to divert from their straight line route, if necessary, to collect images of those segments too. The display features information about the value to the host vehicle operator of collecting the images in those locations. The value may feature a surcharge if an urgent collection of images is needed by a client, for example after an accident has occurred or before a major construction activity begins.

When a suitable means of communication exists, the RACU transmits to a base station run by the Operating Organisation data concerning the routes segments for which images have been collected and the images themselves. Software in the base station knows which RACU are active and where they are, as the RACU transmit this information when being powered on. The base station transmits to each RACU a database of route segments in need of imaging and in the location of the host vehicle.

Images received into the base station are stored in mass storage. The base station Server maintains control over which clients have access to the images and for which images derived data (for example the location and condition of assets) is also required. When derived data is needed, the Server controls the provision of images to the Raters who view the images and create the database of derived data. Both the images and this derived data are subject to quality assurance checks, the conduct of which is managed by the Server.

When completed images and derived data have passed quality checks the Server makes them accessible to the clients who have paid for access to them. The Server also creates the information from which the Operating Organisation can bill clients and pay Raters and Host Vehicle operators.

The benefits of arrangements include the sharing of costs amongst multiple users, thereby enabling more users to be attracted and the ability of the Operating Organisation to charge for images on a subscription basis, leading to a more sustainable business process.

Other aspects and preferred aspects are disclosed in the specification and/or defined in the appended claims, forming a part of the description of the invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Further disclosure, objects, advantages and aspects of the present application may be better understood by those skilled in the relevant art by reference to the following description of preferred embodiments taken in conjunction with the accompanying drawings, which are given by way of illustration only, and thus are not limitative of the present invention, and in which:

FIG. 1 is a block diagram of a system according to a preferred embodiment of the present invention; and

FIGS. 2 to 6 are a block diagrams each providing a detailed view of a component of the system shown in FIG. 1.

### DETAILED DESCRIPTION

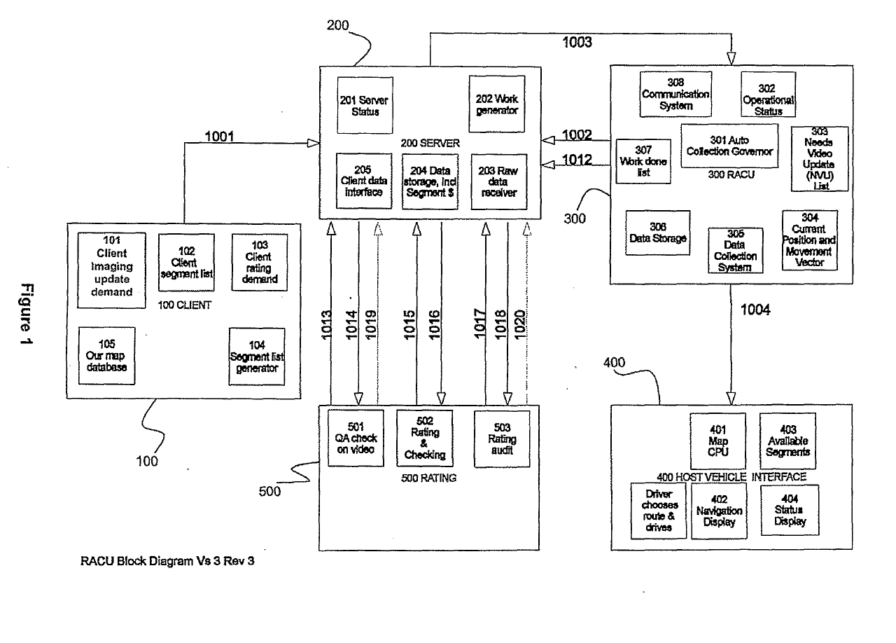

Referring to FIG. 1 there is shown a preferred embodiment of the present invention. The embodiment provides for the digital representation, identification, location, classification and condition assessment of assets distributed on a network accessible by means of transportation, including but not limited to pedestrian, road, rail, ship, aircraft routes. In the embodiment pictures of landscapes and transport routes are collected and databases of asset condition information generated where the assets are part of or distributed along a transport route or pedestrian route. In this regard it is to be understood that geographic information includes asset information given that assets are distributed over a network.

Within the system there is a plurality of vehicles having cameras mounted thereon. As will become apparent the vehicles are used in the formation and maintenance of a large database of imaging and associated data, which is made available to third party users of geographic information. The embodiment provides a method of data collection and storage as well as a process for making landscape imagery available to users in numerous industries in a practical way that allows for routinely refreshing the imaging, thereby ensuring their value is maintained. The images are derived from illumination sources that include visual light, radar, infrared and laser sources.

With this particular embodiment the condition of roads, kerbs and gutters and footpaths is monitored by equipping vehicles in a fleet of vehicles performing a primary service, with imaging equipment; capturing geographical data using the imaging equipment for later use in a store of geographical data. In this manner the collection of imaging is considered to be advantageous given that transportation vehicles transporting goods or persons as a primary service will cover a wide area on a regular basis and will not be dependent on funds generated by the collection imaging data as are specialist vehicles and crews who monitor bitumen and road quality as their primary service.

With the database the imaging taken of road surfaces and kerbs and gutters is given a commercial value in asset management that would not otherwise be present. Furthermore, the collection of imaging is made available for numerous industries including for example council management, business and personal directories, real estate sales, tourism, publicity, Google Earth, Amazon A9 and so forth. The embodiment accordingly provides a system and process involving the collection of pictorial imaging of landscapes, features and assets by vehicles travelling transport and pedestrian routes wherein the pictorial imaging information is distributed to multiple users.

The pictorial imaging is conducted in an advantageous regular and frequent manner such that the value of the imaging increases to both traditional asset management and new geographical information system users of the imaging. The systems and methods provide means of gaining access to the imaging for the purposes of their use in various geographical information system applications and for the purpose of reviewing them to enable features and assets to be identified, located and their condition assessed. The collection of pictorial imaging of landscapes, features and assets is preferably done at reduced cost and with increased regularity and in a form that is more attractive to the other potential users of the imaging.

It is considered that the reduced costs of image collection for the types of images involved will be particularly attractive to route asset managers and that with urban streetscape imaging collected at an economical cost, it will be feasible to renew the imaging every six months or similar. In other embodiments the imaging may be renewed say every one or two months.

As shown in FIG. 1 there is a system module 100 Client having a function which establishes the geographical data used to identify where pictorial imagery is required, when it is required to be updated and where the identification, location and condition rating of assets and features is required. There is a module 200 Server having a function which generates work lists for a module 300 RACU and module 500 Rating, stores imaging and asset and feature identification, location and condition data, and manages the distribution of stored data to 100 Client.

The module 300 RACU has a function which collects pictorial imaging on an opportunistic basis as the host vehicle, that is one of the fleet of transportation vehicles, moves around the transport route network and sends those imaging back to the server as the opportunity so arises.

There is a module 400 Host Vehicle Interface having a function which informs the host vehicle operator which part of the route and network close to the route on which or location at which the host vehicle is travelling requires the collection of images. The 400 Host Vehicle Interface informs the host vehicle operator that the system needs pictorial imaging to be collected and of the status of 300 RACU itself. The 400 Host Vehicle Interface also provides a moving map display and audible navigation prompts for the operator's use.

The function of the 500 Rating is to check the quality of the pictorial imaging collected and perform the identification, location and condition rating of assets and features present in the pictorial imaging.

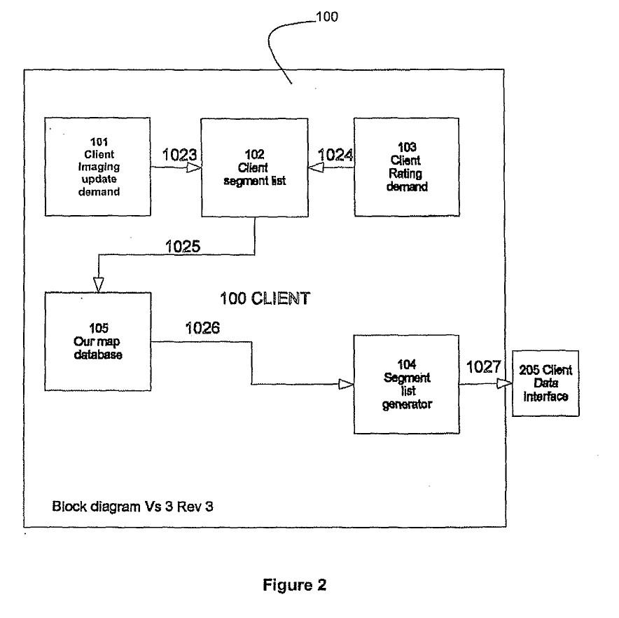

With reference to FIG. 2 in 100 Client, 101 Client Imaging Update Demand is an interface with the orders of clients for updated pictorial imaging. This may be a standing order for regular attention, or a special order for particular parts of the network.

In 100 Client, 102 Client Segment List involves the preparation of a database of information that defines by GPS co-ordinates the location of the start and end points of segments of the route network of interest and notes whether these segments require rating.

In 100 Client, 103 Client Rating Demand is an interface with the orders of clients for “rated” data from collected imaging. Rated data is one or all of the identification, location and condition information of an asset or feature appearing in the pictorial imagery.

In 100 Client, 104 Segment List Generator creates, from 105 Our Map Database, a file of route segments (e.g. From start to feature 1, feature 1 to feature 2 etc.) that show the start and stop chainages (distances). This file is relevant to the geographic area of interest to the clients for “rated” data. This file is made available to 205 Client Data Interface.

In 100 Client, 105 Our Map Database is a Geographic Information System (GIS) file of the network segments in a complete area, such as is created for example by specialist route directory companies in urban areas when the network is a collection of routes.

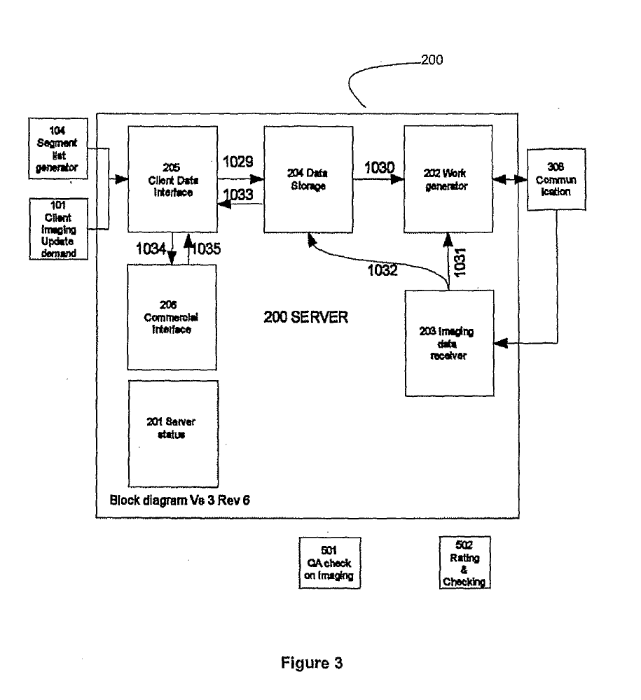

With reference to FIG. 3, in 200 Server, 201 Server Status is a function that monitors and controls the various processes taking place in 200 Server, as described below. 202 Work Generator is a function that determines the need for either image collection work or “rating” work and creates work lists for use by these processes. 202 Work Generator communicates with 300 RACU through 308 Communication and with 500 Rating through 501 QA Check on Imaging and 502 Rating and Checking. 202 Work Generator makes use of 202.1 Radius of Interest received from a 300 RACU.

In 200 Server, 203 Imaging Data Receiver is a function that receives raw data from 300 RACU through 308 Communication, advises 202 Work Generator of the receipt of raw (unchecked) data and places the received raw data in 204 Data Storage.

In 200 Server, 204 Data Storage is the repository of all data, namely imaging data received from 203 Raw Data Receiver and “rated” data from 500, Rating from 501 QA Check on Imaging and 502 Rating and Checking.

A feature of 204 Data Storage comprises 204.1 Master Segment List. A further feature is 204.2 Segment Collection Value which comprises a data item associated with segment records in the 204 Data Storage.

In 200 Server, 205 Client Data Interface is a function that organises the listing of client street segments from 104 Segment List Generator, records requests from clients (of rating data or of image data) for data to be updated received from 101 Client Imaging Update Demand. This function ensures that 204 Data Storage contains data items needed for this purpose.

In 200 Server, 206 Commercial interface is a function that identifies that imaging work or rating work requested by 100 Client has been completed in full or in part, by reference to 204 Data Storage, 101 Client Imaging Update Demand and 103 Client Rating Demand. 206 Commercial Interface communicates this availability to Imaging Clients and Rating Clients by means that include, but are not limited to E-mail, ftp and letter. 206 Commercial Interface determines the value of the available data from value data that has been loaded into 205 Client Data Interface by the Operating Organisation and displays, by means that include but are not limited to paper and electronic, an invoice for the Operating Organisation to process. 206 Commercial Interface identifies completed rating work by reference to 204 Data Storage and prints a remittance advice in favour of the 500 Rating Organisation for the Operating Organisation to process from value data entered into 206 Commercial Interface by the Operating Organisation. 206 Commercial Interface identifies completed imaging work by reference to 204 Data Storage and advises Imaging Clients of its availability through 205 Client Data Interface. 206 Commercial Interface sets flags in 205 Client Data Interface that allow Imaging Clients and Rating Clients to access the data in 204 Data Storage. 206 Commercial Interface is used by the Operating Organisation to enter accounts received data. 206 Commercial Interface daily applies rules entered by the Operating Organisation to reprint invoices, print statements and curtail access by clients whose payments have not been received.

In 300 RACU, 301 Auto Collection Governer provides the overall co-ordination and management of the variety of autonomous functions of 300 RACU, which are described below.

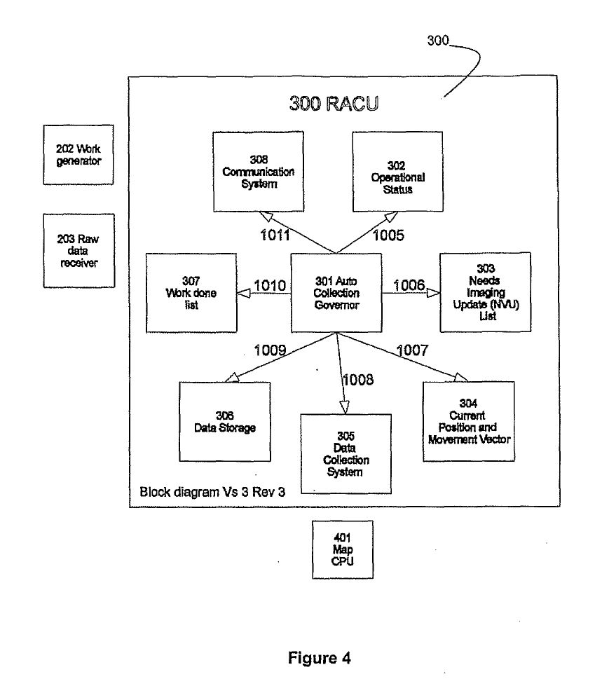

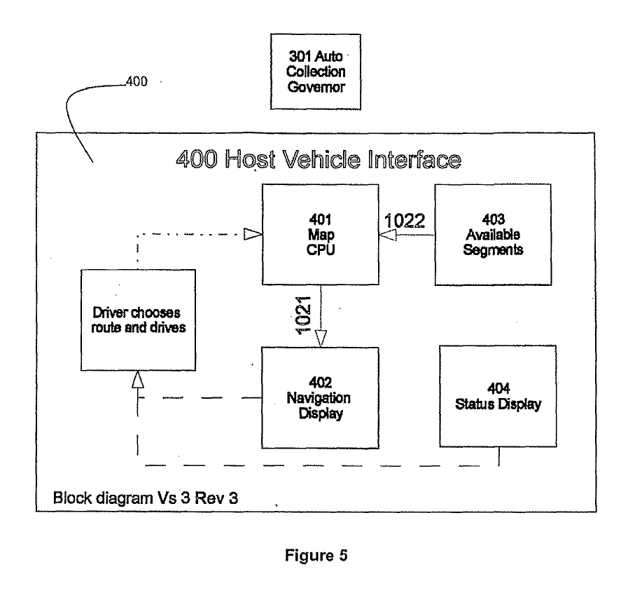

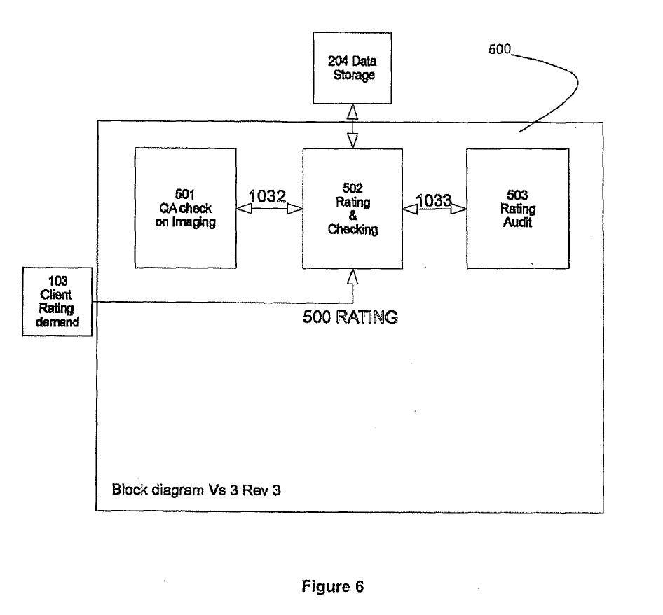

With reference to FIG. 4, in 300 RACU, 302 Operational Status is a function that determines the status of the navigation, optical and communication equipment contained in 300 RACU and communicates that to 301 Auto Collection Governer and notes ambient conditions through sensors integrated with the image collection devices, for example, but not limited to, illumination levels for visual imagery, rain or other contamination of lens windows.

In 300 RACU, 303 Needs Imaging Update List is a storage of route segment data in proximity to 300 RACU that has been communicated from 202 Work Generator via 308 Communication.

In 300 RACU, 304 Current Position and Movement Vector is a function provided by the outputs of equipment that includes, but is not limited to, GPS receiver(s), inertial, odometer and magnetic navigation system contained within the body of 300 RACU. 304 Current Position and Movement Vector communicates this information to 301 Auto Collection Governer.

304.1 Navigation System is the navigation technology being used by 300 RACU to determine the location and direction of travel of the host vehicle. 304.1 Navigation System may include, but not be limited to, GPS, inertial navigation assemblies, compass and odometer.

In 300 RACU, 305 Data Collection System is a number of imaging devices (the Imaging Array), which could be but are not limited to optical cameras, obtaining data from the surroundings in which 300 RACU is moving. 305 Data Collection System is controlled by 301 Auto Collection Governer, which tells it when to start and stop data collection.

305.1 Imaging Array is the imaging technology being used by 305 Data Collection System to gather imaging data. 305.1 Imaging Array may include, but not be limited to optical cameras, lasers, microwave transmitters, infra-red beams, lasers etc.

305.2 Trigger Box is the method used by 305 Data Collection System to signal the activation of 305.1 Imaging Array. This trigger may be based on parameters such as, but not limited to, distance, position, orientation and time. In 300 RACU, 306 Data Storage is a mass data storage for the output of the imaging devices of 305 Data Collection System and associated location and time data collected by 300 RACU.

In 300 RACU, 307 Work Done List is a list created by 301 Auto Collection Governer from 306 Data Storage that accumulates an index of route segments that have been collected by 300 RACU. This index is communicated to 200 Server through 308 Communication at times determined by 301 Auto Collection Governer.

In 300 RACU, 308 Communication evaluates the type and quality of communication channels available to 300 RACU and communicates this information to 301 Auto Collection Governer. 301 Auto Collection Governer decides when communication with 200 Server is feasible and commands the transmission of data associated with the 307 Work Done List as the opportunity arises. 301 Auto Collection Governer places a priority on transmission of the 307 Work Done List. Other data items associated with the 307 Work Done List are transmitted when a high quality communication signal is identified that is in accordance with rules contained within 301 Auto Collection Governer.

In 400 Host Vehicle Interface, 401 Map CPU processes the movement and position vector obtained from 304 Current Position and Movement Vector via 301 Auto Collection Governor to signal 402 Navigation Display. 401 Map CPU also receives optional destination information from the Operator of 300 RACU and determines route choices based on options that include, but are not limited to, shortest distance and route that maximises payment for data collection.

In 400 Host Vehicle Interface, 402 Navigation Display is a screen display of location and direction on the network being navigated by the host vehicle, together with navigation guidance and indications by colour or other means of the collection value of segments in the neighbourhood of the vehicle, this information being obtained from 403 Available Segments,

In 400 Host Vehicle Interface, 403 Available Segments is a function that provides data via 301 Auto Collection Governor from 303 Needs Imaging Update List in a format suited to 401 Map CPU. This may be provided with colour formatting on the available segments as shown in the form of a map.

In 400 Host Vehicle Interface, 404 Status Display is a display for the benefit of the Host Vehicle operator of information about the status of the 300 RACU. This information consists of, but is not limited, to service status (e.g. Serviceable, unserviceable, poor data collection conditions, system check being performed, on standby, preparing to collect data, collecting data) and communication status (e.g. Receiving, checking, discarding, transmitting, incomplete transmission and complete transmission).

In 500 Rating, 501 QA Check on Imaging is a sampling check on the imagery collected by 300 RACU. Selection of imaging data, for a QA check, is based on criteria that include, but are not limited to, a minimum proportion of the imaging collected and adverse ambient condition data noted by 301 Auto Collection Governor through 302 Operational Status. The QA check sample listing is created by 202 Work Generator.

In 500 Rating, 502 Rating and Checking is the process of viewing the collected imagery in order to do one or more of identifying, classifying, locating and rating the condition of items of interest to clients. The viewing process may include, but not be limited to, observation of visual imagery by people or scanning of image content by computers. 502 Rating and Checking is prompted by 103 Client Rating Demand. The output of 502 Rating and Checking is a data file attached to the imagery that includes the results of the rating and checking process. This data file is stored in 204 Data Storage.

In 500 Rating, 503 Rating Audit is a function to check the quality of rating performed under 502 Rating and Checking. A defined proportion of rating and checking work is re-done to evaluate the repeatability of the results 503 Rating Audit contains a rating and checking data collection process and an automated evaluation of statistical repeatability measures. Rating and Checking work that fails the repeatability measures is either re-rated or re-collected. In the latter case the need is flagged in 204 Data Storage and recognised by 202 Work Generator.

The work flow process of the embodiment is described in this way: A client for rated information (a Rating Client) expresses an interest in obtaining rating data of features of the client's street or other transport network,

1 The Rating Client and the organisation operating the invention (the Operating Organisation), define the asset classes and rating requirements and define the geographic boundaries of the area of the Rating Client's interest.

2 The Operating Organisation creates a database of node and link identifiers, for example route and route segment, that identify points that encompass the Rating Client's area of interest.

3 The Operating Organisation enters this database onto the server.

4 The Server recognises the need for data to be collected in this geographical area and includes it in the list of work required that is made available to RACU operating in that area.

5 RACU receives notification of the requirement and the information is displayed for the Host Vehicle Operator, who opportunistically responds to the request for imaging.

6 The RACU transmits the collected imaging data to the Server as raw data.

7 The Server recognises that the provided imaging data needs the rating specified by the Rating Client and makes the database available to the Raters for both a quality check on collected imaging and for rating.

8 When raters log in to the Server, the database is available to them and they do the required imaging quality check.

9 When imaging passes the quality check it is made available to the Rating Client and to the Operating Organisation for sale also to Imaging Clients.

10 Imaging data that has passed the quality check is made available by the Server for rating.

11 Imaging that does not pass the quality check is noted by the Server and returned to the queue of database of node and link identifiers that require imaging work by RACUs.

12 Completed rating work is stored in the Server and a sample of it is marked for auditing, this being returned to the rating work queue.

13 When a batch of rating work passes the rating audit it is stored in the Server as available for access by the Rating Client, who is notified by the Server through agreed means that include, but are not limited to E-mail.

14 When a batch of rating work fails the rating audit it is returned to the raters.

15 The Server generates an invoice to Rating Clients for rating work that has passed the rating quality assurance check.

16 The Operating Organisation enters Rating Client accounts received data into the Server.

17 The Server advises Imaging Clients of the availability of requested imaging data by agreed means that include but are not limited to E-mail.

18 The Server generates invoices to Imaging clients and transmits them by means that include, but are not limited to, E-mail.

19 The Operating Organisation enters Imaging Client accounts receivable data into the Server.

20 The Server checks accounts receivable data on a daily basis and applies rules entered by the Operating Organisation to determine whether database access by either Rating or Imaging Clients is allowed.

Detail of Common Operating Units is now provided. Several exemplary descriptions follow.

### 1001 Add to Data for Update List.

In the embodiment 1001 Add to Data for Update List, is the process by which 100 Client requests data capture from 200 Server.

1001 Add to Data for Update List contains the following steps:
1001.1 Adhoc Data Request—A user requests data capture through methods not limited to but including the following: Web page interface, Formal written request, Audio request, Request generated by a third party program.
1001.2 SLA Triggered Request—The request comes from a structured agreement not limited to but including the following: Service Level Agreement (SLA) Contract Management Program, Internal Data Capture Standard
1001.3 Data Request Translator—This request integrates data not limited to but including the following types: Time limit, Price to pay, segment details, such as but not limited to 102 Client route Segment List, Geographical data
1001.4 Transmit Request to 200 Server—Transmission may use methods not limited to but including the following: Ethernet network, Internet network, Physical data storage device, such as but not limited to CD-ROM, portable hard disk drive or solid state memory device,
1001.5 200 Server Receives Request

### 1002 Request Needs Imaging Update (NIU) List

In the embodiment 1002 Request Needs Imaging Update (NIU) List, is the process by which 300 RACU requests the 303 NIU List from 200 Server.

1002 Request Needs Imaging Update (NIU) List contains the following steps:
1002.1 300 RACU Startup—Procedures not limited to but including the following:
   300 RACU powers on,
   300 RACU performs a self test,
   300 RACU determines its location,
   300 RACU determines if it can communicate with 200 Server,
1002.2 300 RACU Initiate Request—Procedures not limited to but including the following:
   300 RACU identifies itself to 200 Server,
   300 RACU sends its location to 200 Server,
   300 RACU requests 303 NIU List from 200 Server.
If this is the first request for the day, 300 RACU requests a date and time synchronisation from the server.

### 1003 200 Server Transmits 303 NIU List

In the embodiment 1003 200 Server Transmits 303 NIU List, is the process by which 200 Server transmits the 303 NIU List to 300 RACU.

1002 200 Server Transmits 303 NIU List contains the following steps:
1003.1 200 Server receives 1002 Request Needs Imaging Update (NIU) List
1003.2 200 Server passes location from 1002 Request Needs Imaging Update (NIU) List to 202 Work Generator
1003.3 202 Work Generator determines 202.1 Radius of Interest based on a rule set
1003.4 202 Work Generator determines the intersection between 204.1 Master Section List, 202.1 Radius of Interest, and segments which need to be done, but not segments offered to another 300 RACU within a time limit set by the Operating Organisation.
1003.5 300 RACU receives 303 NIU List from 200 Server.
1003.6 If a date and time synchronisation was requested, 200 Server initiates a network time protocol update with 300 RACU.
   1004 300 RACU Communicates with 400 Host Vehicle Interface

In the embodiment 1004 300 RACU Communicates with 400 Host Vehicle Interface, is the process by which 300 RACU conveys navigational information, operational status and the network segments in need of imaging to 400 Host Vehicle Interface and in conjunction with the Host Vehicle Operator, determines 402 Navigation Display.

1004 300 RACU Communicates with 400 Host Vehicle Interface contains the following steps:
1004.1 300 RACU sends operational status to 404 Status Display.
1004.2 300 RACU sends navigational information to 401 Map CPU
1004.3 300 RACU sends the Needs Imaging Update List to the 403 Available Segments data storage
1004.4 The Host Vehicle Operator inputs the destination, this step is optional.
1004.5 If a destination has been given, 300 RACU determines driving route options, including but not limited to the following:
   Shortest route from current position to destination.
   Quickest route from current position to destination.
   Longer route from current position to destination offering higher value segments.
   An even longer route from current position to destination offering even higher value segments.
1004.6 Whether a destination has been given or not, 400 Host Vehicle Interface displays a moving map which indicates the 204.2 Segment Collection Value on segments in the 402 Navigation Display.

### 1005 301 Auto Collection Governor Checks 302 Operational Status

In the embodiment 1005 301 Auto Collection Governor checks 302 Operational Status, is the process by which 301 Auto Collection Governor checks whether the 300 RACU system is capable of collecting Imaging data.

1005 301 Auto Collection Governor checks 302 Operational Status contains the following steps:
1005.1 301 Auto Collection Governor requests operational status report from 302 Operational Status.
1005.2 302 Operational Status reports on the operational status of all aspects of equipment needed for the data collection activity, including but not limited to the following:
   The functional status and communication status for each imaging device (for example an optical camera) in 305 Data Collection System.
   The image quality parameters for each imaging device in 305 Data Collection System. Image quality parameters reported for an optical camera, for example would include but not be limited to the following:
      Contrast
      Colour balance
      Dirty Lenses
      Rain drops on lenses
      Light level
   The functional status of the 304.1 Navigation System, which includes but is not limited to the positional accuracy.
   The functional status of 400 Host Vehicle Interface.
   The functional status of 306 Data Storage, including but not limited to the amount of free space.
   The functional status of the 305.2 Trigger Box.
1005.3 301 Auto Collection Governor decides whether collection is possible.
1005.4 301 Auto Collection Governor updates display of operational status to 400 Host Vehicle Interface.

### 1006 301 Auto Collection Governor Checks 303 NIU List

In the embodiment 1006 301 Auto Collection Governor checks 303 NIU List, is the process by which 301 Auto Collection Governor checks whether the 303 NIU List is still current.

1006 301 Auto Collection Governor checks 303 NIU List contains the following steps:
1006.1 301 Auto Collection Governor retrieves the age of the 303 NIU List, the expiry age of the 303 NIU List and the 202.1 Radius of Interest for the 303 NIU List.
1006.2 301 Auto Collection Governor checks if the 303 NIU List is beyond its expiry age or if the 300 RACU has traveled more than a defined straight line distance from its location at time of receipt of 303 NIU List, and if it fails either of these checks sends a 1002 Request Needs Imaging Update (NIU) List through 308 Communication System.

### 1007 301 Auto Collection Governor Retrieves 304 Current Position and Movement Vector

In the embodiment 1007 301 Auto Collection Governor retrieves 304 Current Position and Movement Vector, is the process by which 301 Auto Collection Governor determines its current position and movement direction in order to determine whether 300 RACU is approaching, within or departing a segment listed in 303 NIU List.

1007 301 Auto Collection Governor retrieves 304 Current Position and Movement Vector contains the following steps:
1007.1 301 Auto Collection Governor retrieves the 300 RACU current position, heading and speed from 304.1 Navigation Unit in terms of but not limited to the following parameters:
   Latitude
   Longitude
   Height
   Compass direction
   Roll
   Pitch
   Speed
   Statement of quality of positional accuracy.
1007.2 301 Auto Collection Governor compares this information with the geographical parameters in the 303 NIU List and 401 Map to determine if 300 RACU is approaching, within or departing a segment listed as needing collection in 303 NIU List.

### 1008 301 Auto Collection Governor Operates 305 Data Collection System

In the embodiment 1008 301 Auto Collection Governor operates 305 Data Collection System, is the process by which 301 Auto Collection Governor starts, continues or stops the 305 Data Collection System.
1008 301 Auto Collection Governor operates 305 Data Collection System contains the following steps:
1008.1 In the case where 300 RACU is not approaching, within or departing a segment on the 303 NIU List, 301 Auto Collection Governor places 305 Data Collection System into standby mode. In standby mode 305 Data Collection System performs operations such as, but not limited to the following:
   Triggering imaging devices by time interval rather than distance interval for the purposes of 302 Operational Status checking.
   Reading data from 304.1 Navigation System for the purposes of 302 Operational Status checking and updating 402 Navigation Display.
1008.2 In the case where 300 RACU is approaching, within or departing a segment on the 303 NIU List, 301 Auto Collection Governor places 305 Data Collection System into operational mode. In operational mode 305 Data Collection System performs operations such as, but not limited to the following:
   Initialising the 305.2 Trigger Box which includes but is not limited to:
      Resetting distance measurement at the start of the segment.
      Setting the various camera distance trigger intervals.
      Setting the 305.2 Trigger Box reporting intervals.
      During data acquisition along the segment, 301 Auto Collection Governor checks that the traveled path of 300 RACU is within acceptable limits. If the traveled path of 300 RACU deviates from within the acceptable limits for the segment, then data capture is cancelled and stored information for the segment is discarded.
      Sending data to 306 Data Storage, including but not limited to the following data:
         The image records from each imaging device.
         The 304.1 Navigation System output, as outlined in 1007.1.
         Date and time stamps.
         Segment details from 303 NIU List
         A log of 302 Operational Status reporting.
      On departing a segment, 301 Auto Collection Governor performs operations including but not limited to the following:
         Placing 305 Data Collection System into standby mode.
         Stopping the sending of data to 306 Data Storage.
         Sending a completed segment notification to 307 Work Done List.

### 1009 301 Auto Collection Governor Sends Data to 306 Data Storage

In the embodiment 1009 301 Auto Collection Governor sends data to 306 Data Storage, is the process by which 301 Auto Collection Governor stores the collected data.

1009 301 Auto Collection Governor sends data to 306 Data Storage contains the following steps:
1009.1 During data acquisition, 301 Auto Collection Governor stores data in its system memory.
1009.2 Satisfactory data is then sent to 306 Data Storage, where it is written onto a redundant form of storage including but not limited to the following types of storage:
   Hard disk drives.
   Solid state memory.
   Network attached storage, which may or may not be physically attached to 300 RACU.

### 1010 301 Auto Collection Governor Sends Completed Segment Notification to 307 Work Done List

In the embodiment 1010 301 Auto Collection Governor sends completed segment notification to 307 Work Done List, is the process by which 301 Auto Collection Governor maintains a record of segments from 303 NIU List which it believes it has completed successful data capture on.

1010 301 Auto Collection Governor sends completed segment notification to 307 Work Done List contains the following steps:
1010.1 Following data acquisition, 301 Auto Collection Governor compiles a report on the successful completion of the segment. This report contains, but is not limited to the following information:
   The segment details as obtained from 303 NIU List.
   The unique ID of the 300 RACU.
   The date and time stamps for the starting and ending of collection.
   The log from 302 Operational Status reporting, including Imaging quality estimates.
   A log of the traveled path of 300 RACU along the segment.
1010.2 The report generated in 1010.1 is stored in 307 Work Done List
   1011 301 Auto Collection Governor Communicates with 200 Server Using 308 Communication System

In the embodiment 1011 301 Auto Collection Governor communicates with 200 Server using 308 Communication System, is the process by which 301 Auto Collection Governor sends to and receives information from 200 Server.

1011 301 Auto Collection Governor communicates with 200 Server using 308 Communication System contains the following steps:
1011.1 308 Communication System provides a report to 301 Auto Collection Governor including but not limited to the connection bandwidth available.
1011.2 308 Communication System sends and receives data based on the instructions given by 301 Auto Collection Governor.

### 1012 300 RACU Sends Completed Data to 200 Server

In the embodiment 1012 300 RACU Sends Completed Data to 200 Server, is the process by which 300 RACU sends the completed data to 200 Server.

1012 300 RACU sends completed data to 200 Server contains the following steps:
1012.1 308 Communication System identifies what network communication options are attached and what the theoretical transfer rates are for each option. Available network communication types include but are not limited to the following:
   GSM type mobile Internet connection.
   3G type mobile internet connection.
   802.11a/b/g wireless Internet connection.
   10/100/1000 Mbit wired Ethernet connection.
1012.2 If any network connection is available, then 301 Auto Collection Governor instructs 308 Communication System to send data including but not limited to any unsent segment data in the 307 Work Done List.
1012.3 If a high bandwidth network connection is available, then 301 Auto Collection Governor instructs 308 Communication System to send data including but not limited to the following:
   Any unsent segment data in the 307 Work Done List.
   Any unsent digital imagery data stored in 306 Data Storage.
1012.4 If 303 NIU List needs updating, as determined by 1006.2, then 301 Auto Collection Governor instructs 308 Communication System to send 1002 Request Needs Imaging Update (NIU) List.
1012.5 308 Communication System sends the requested data plus a check sum for error checking purposes to 203 Imaging Data Receiver.
1012.6 203 Imaging Data Receiver receives the sent data and the check sum for the data.
1012.7 203 Imaging Data Receiver checks that the data was received without error using the supplied checksum.
1012.8 If there are no errors with the data received by 203 Imaging Data Receiver, then 203 Imaging Data Receiver replies to 308 Communication System saying that the data has been received OK.
1012.9 If there are errors with the data received by 203 Imaging Data Receiver, then 203 Imaging Data Receiver replies to 308 Communication System saying that the data should be resent.
1012.10 When the data received OK message is received by 308 Communication System, the transmission OK message is sent to 301 Auto Collection Governor.
1012.11 301 Auto Collection Governor deletes successfully sent data from 306 Data Storage.

### 1013 501 QA Check on Imaging Requests Needs QA Check (NQAC) List

In the embodiment 1013 501 QA Check on Imaging Requests Needs QA Check (NQAC) List, is the process by which 501 QA Check on Imaging requests a list of collected Imaging segments that need a QA check on the Imaging quality from 202 Work Generator.
1013 501 QA Check on Imaging Requests Needs QA Check (NQAC) List contains the following steps
1013.1 A person qualified to perform Imaging quality checking logs into the 501 QA Check on Imaging system.
1013.2 501 QA Check on Imaging requests NQAC List from 202 Work Generator. The request includes but is not limited to the following information:
   The name of the rater.
   The qualifications of the rater.
   The type of rating work the rater is requesting.

### 1014 202 Work Generator Transmits Needs QA Check (NQAC) List

In the embodiment 1014 202 Work Generator transmits Needs QA Check (NQAC) List, is the process by which 202 Work Generator prepares a list of collected Imaging segments that need a QA check on the Imaging quality and transmits this to 501 QA Check on Imaging.

1014 501 QA Check on Imaging Requests Needs QA Check (NQAC) List contains the following steps:
1014.1 202 Work Generator receives a request for a NQAC List.
1014.2 202 Work Generator determines the intersection between 204.1 Master Section List and 307 Work Done List but excludes segments which need rating work performed.
1014.3 202 Work Generator ranks these segments starting at the lowest Imaging quality estimate recorded in 1010.1.
1014.4 202 Work Generator then selects a portion of the segments having the worst Imaging quality estimates based on the Imaging quality audit proportion determined in 103 Client Rating Demand.
1014.5 202 Work Generator transmits the NQAC List to 501 QA Check on Imaging

### 1015 502 Rating and Checking Requests Needs Rating (NR) List

In the embodiment 1015 502 Rating and Checking requests Needs Rating (NR) List, is the process by which 502 Rating and Checking requests a list of collected Imaging segments that need rating work from 202 Work Generator.
1015 502 Rating and Checking Requests Needs Rating (NR) List contains the following steps:
1015.1 A person qualified to perform Imaging rating work logs into the 502 Rating and Checking system.
1015.2 502 Rating and Checking requests NQAC List from 202 Work Generator. The request includes but is not limited to the following information:
   The name of the rater.
   The qualifications of the rater.
   The type of rating work the rater is requesting.

### 1016 202 Work Generator Transmits Needs Rating (NR) List

In the embodiment 1016 202 Work Generator transmits Needs Rating (NR) List, is the process by which 202 Work Generator prepares a list of collected Imaging segments that need rating work and transmits this to 502 Rating and Checking.

1016 202 Work Generator transmits Needs Rating (NR) List contains the following steps:
1016.1 202 Work Generator receives a request for a NR List.
1016.2 202 Work Generator determines the intersection between 204.1 Master Section List, 307 Work Done List, and 103 Client Rating Demand.
1016.3 202 Work Generator ranks these segments in the order that they were collected by the various 300 RACU.
1016.4 202 Work Generator transmits the NR List to 602 Rating and Checking.

### 1017 503 Rating Audit Requests Needs Rating Audit (NRA) List

In the embodiment 1017 503 Rating Audit requests Needs Rating Audit (NRA) List is the process by which 503 Rating Audit requests a list of rating completed segments that need a sample of the rating work audited from 202 Work Generator.

1017 503 Rating Audit Requests Needs Rating Audit (NRA) List contains the following steps:
1017.1 A person qualified to perform auditing of Imaging rating work logs into the 603 Rating Audit system.
1017.2 503 Rating Audit requests NRA List from 202 Work Generator. The request includes but is not limited to the following information:
   The name of the audit rater.
   The qualifications of the audit rater.
   The type of rating work the audit rater is requesting.

### 1018 202 Work Generator Transmits Needs Rating Audit (NRA) List

In the embodiment 1018 202 Work Generator transmits Needs Rating Audit (NRA) List, is the process by which 202 Work Generator prepares a list of completed rating segments that need a sample of the rating work audited and transmits this to 503 Rating Audit.

1018 202 Work Generator transmits Needs Rating Audit (NRA) List contains the following steps:
1018.1 202 Work Generator receives a request for a NRA List.
1018.2 202 Work Generator determines the intersection between 204.1 Master Section List, 307 Work Done List, rating work session records which show which segments were rated by each rater in a work session and segments previously marked as OK by sample audits done by the Rating Contractor at the time of rating.
1018.3 202 Work Generator performs a random selection of a subsample of the list generated in 1016.2. The subsample is based on audit requirements defined in 103 Client Rating Demand, which includes but is not limited to the following parameters:
   The percentage of segments rated by each rater in a rating session which should be audited.
   The limits of variation between the original rating and the audit rating at which an audit is defined as passing or failing.
1018.4 202 Work Generator ranks the segment list obtained in 1018.3 in the order that they were collected by the various 300 RACU,
1018.5 202 Work Generator transmits the NRA List to 503 Rating Audit,

### 1019 501 QA Check on Imaging Transmits QA Check Results to 204 Data Storage

In the embodiment 1019 501 QA Check on Imaging transmits QA check results to 204 Data Storage, is the process by which 501 QA Check on Imaging prepares a report on the results of the QA checks on imaging and transmits this to 204 Data Storage for recording.

1019 501 QA Check on imaging transmits QA check results to 204 Data Storage contains the following steps:
1019.1 A person qualified to perform Imaging quality checking logs on to the 501 QA Check on Imaging system.
1019.2 This person views the imaging in the list of records contained in the Needs QA Check List obtained in 1014 and records the assessment result based on criteria provided in 101 Client Imaging Update Demand.
1019.3 The QA checker uploads the completed QA check file to 204 Data Storage.
1019.4 If the batch of data has passed the QA check, 204 Data Storage marks all records in that collection batch in the Master Segment List as acceptable.
1019.5 If the batch of data fails the QA check, 204 Data Storage marks all the records in that collection batch in the Master Segment List as not acceptable and in need of re-collection.

### 1020 502 Rating and Checking Transmits Rating Data to 204 Data Storage

In the embodiment 1020 502 Rating and Checking transmits rating data to 204 Data Storage, is the process by which 502 Rating and Checking records its rating data into the 204 Data Storage.

1020 502 Rating and Checking transmits rating data to 204 Data Storage contains the following steps:
1020.1 A person qualified as a rater logs on to the 502 Rating and Checking System.
1020.2 The rater selects records from the 1015 Needs Rating List and performs the rating.
1020.2 The rater uploads the completed rating data to 204 Data Storage.
1020.3 204 Data Storage marks all the records in the rated batch as rated subject to QA and removes them from the 1015 Needs Rating List.

### 1021 503 Rating Audit Transmits Rating Audit Results to 204 Data Storage

In the embodiment 1021 503 Rating Audit transmits rating audit results to 204 Data Storage, is the process by which 503 Rating Audittransmits rating audit results to 204 Data Storage.

1021 503 Rating Audit Transmits rating audit results to 204 Data Storage contains the following steps:
1021.1 A person qualified as a rating auditor logs on to the 502 Rating and Checking System.
1021.2 The rating auditor selects records from the 1015 Needs Rating List, performs the audit and records the result based on criteria provided by the Operating Organisation.
1021.3 The rating auditor uploads the results to 204 Data Storage.
1021.4 If the batch of rating fails the audit, 204 Data Storage marks all the records in that batch in the Master Segment List as not acceptable and in need of further rating.

### 1022 401 Map CPU Transmits Position Data to 402 Navigation Display

In the embodiment 1022 401 Map CPU transmits position data to 402 Navigation Display is the process by which 401 Map CPU provides position data to 402 Navigation Display. 1022 401 Map CPU transmits position data to 402 Navigation Display contains the following steps:
1022.1 401 Map CPU receives via a means of communication that may be one of, but is not limited to one of wire cable, radio or infrared link from 301 Autocollection Governor data provided by 304 Current Position and Movement Vector
1022.2 401 Map CPU provides this data to 402 Navigation Display
1022.3 402 Navigation Display shows the 300 Host Vehicle Operator location, direction of movement and the imaging collection status of segments in the region of the 300 RACU unit.

### 1023 403 Available Segments Transmits Available Segment Data to 401 Map CPU

In the embodiment 1023 403 Available Segments transmits available segment data to 401 Map CPU is the process by which data from 303 Needs Imaging Update List is obtained via 301 Auto Collection Governor in a format suited to 401 Map CPU for display on 402 Navigation Display.

1023 403 Available Segments transmits available segment data to 401 Map CPU contains the following steps:
1023.1 Knowing its location from 304 Current Position and Movement Vector, 401 Map CPU identifies network segments in 403 Available Segments within the range of the display provided by 402 Navigation Display and makes that information available to the 300 Host Vehicle Operator by means that include, but are not limited to, colour highlighting of segments, changes to image density and changes to segment delineation.

### 1024 101 Client Imaging Update Demand Transmits Image Demand Data to 102 Client Segment List

In the embodiment 1024 101 Client Imaging Update Demand transmits image demand data to 102 Client Segment List is the process by which the Client's network description is converted into segment lists suited to data collection.

1024 101 Client Imaging Update Demand transmits image demand data to 102 Client Segment List contains the following steps:
1024.1 An imaging Client places an order with the Operating Organisation for network imaging to be provided or updated
1024.2 The Imaging Client:
   Provides a geographic specification of the location and boundaries of the network for which imaging is wanted
   Specifies the required segmentation of the links within the network, or the rules by which the Operating Organisation can create segments suited to the Imaging Client
1024.3 The Operating Organisation assembles the 102 Client Segment List database.

### 1025 103 Client Rating Demand Transmits Rating Requirements Data to 102 Client Segment List

In the embodiment 1025 103 Client Rating Demand transmits rating requirements data to 102 Client Segment List is the process which places a flag on the Client's segment lists to indicate that rating is required.

1025 103 Client Rating Demand transmits rating requirements data to 102 Client Segment List contains the following steps:
1025.1 A Rating Client places an order with the Operating Organisation for network rating to be provided or updated
1025.2 The Rating Client:
   Provides a geographic specification of the location and boundaries of the network for which rating is wanted
   Specifies the rating requirements.
1025.3 The Operating Organisation places flags on the 102 Client Segment List database records to indicate the rating requirements.

### 1026 102 Client Segment List Transmits Client Segment Data to 105 Our Map Database

In the embodiment 1026 102 Client Segment List transmits client segment data to 105 Our Map Database is the process by which the Client's imaging needs are aligned with the geospatial information contained in the map database.

1026 102 Client Segment List transmits client segment data to 105 Our Map Database contains the following steps:
1026.1 105 Our Map Database stores the 102 Client Segment List in a buffer storage and temporarily protects it from being overwritten by allocation of a security tag to each record
1026.2 105 Our Map Database locates relevant existing records in itself by reference to link (for example, but not limited to, road) names and the geographic references provided in 102 Client Segment List, which include but are not limited to GPS co-ordinates, map co-ordinates and node identifiers.
1026.3 105 Our Map Database assigns a client identifier to those records that correspond to the transmitted data.
1026.4 105 Our Map Database removes the security tag from relevant records in the buffer storage.

### 1027 105 Our Map Database Transmits Segment Data to 104 Segment List Generator

In the embodiment 1027 105 Our Map Database transmits segment data to 104 Segment List Generator is the process by which the data collection needs of all Clients are assembled in to a master Segment list.

1027 105 Our Map Database transmits segment data to 104 Segment List Generator contains the following steps:
1027.1 105 Our Map Database identifies all segment data relevant to all imaging or rating clients and transmits this to 104 Segment List Generator.
1027.2 104 Segment List Generator calculates start and stop chainages (distances) for all segments along a link and adds them to the records in the Segment List,

### 1028 104 Segment List Generator Transmits Segment Lists to 205 Client Data Interface

In the embodiment 1028 104 Segment List Generator transmits segment lists to 205 Client Data Interface in 200 Server is the process by which the 205 Client Data Interface obtains segment identification data in the form needed to transmit imaging or rating results to clients.

1028 104 Segment List Generator transmits segment lists to 205 Client Data Interface in 200 Server contains the following steps:
1028.1 104 Segment List Generator compares the segment records in 205 Client Data Interface with its own segment records.
1028.2 104 Segment List Generator adds a security tag to all records that need to be included or revised in 205 Client Data Interface.
1028.3 104 Segment List Generator transmits all records that need to be included or revised in 205 Client Data Interface.
1028.4 104 Segment List Generator marks all transmitted records with the date and time of transmission.

### 1029 205 Client Data Interface Transmits Segment Data to 204 Data Storage

In the embodiment 1029 205 Client Data Interface transmits segment data to 204 Data Storage is the process by which database records are created in 204 Data Storage ready for the addition of imagery and rating data as this work is done.

1029 205 Client Data Interface transmits segment data to 204 Data Storage contains the following steps:
1029.1 205 Client Data Interface compares the segment records in 204 Data Storage with its own segment records and transmits segment records that need to be included or revised in 204 Data Storage. If new segment records need to be included in 204 Data Storage, new segment records are created and marked with the date and time of their creation. If segment records need to be revised, existing segment records in 204 Data Storage (other than existing images and rating data associated with the segment record) are overwritten and the date and time of their revision recorded in the record.
1029.2 205 Client Data Interface removes the security tag placed in step 1028.2 from these records, allowing them to be overwritten as necessary.

### 1030 204 Data Storage Transmits Data to 202 Work Generator

In the embodiment, 1030 204 Data Storage transmits data to 202 Work Generator is the process by which 202 Work Generator assembles lists of segments that require either image collection or rating work.

1030 204 Data Storage transmits data to 202 Work Generator contains the following steps:
1030.1 202 Work Generator searches the records in 204 Data Storage to identify records with missing data.
1030.2 202 Work Generator creates a list of segments that require imaging data to be collected. This involves:
   Identifying records with no associated imaging data
   Identifying records whose imaging data needs to be revised, either because it is reaching the end of its validity period or because a client has placed a special order for revision
1030.3 202 Work Generator creates a list of segments that require rating. This involves:
   Identifying records with associated imaging data for which rating is required but has not been done
   Identifying the rating scheme required by the rating client.

### 1031 203 Imaging Data Receiver Transmits to 202 Work Generator

In the embodiment, 1031 203 Imaging Data Receiver transmits to 202 Work Generator is the process by which 202 Work Generator is notified of the recent collection of imaging data so that its list of required imaging work is revised in as close to real time as 308 Communication allows.

1031 203 Imaging Data Receiver transmits to 202 Work Generator contains the following steps:
1031.1 Immediately on receipt of collected imaging segment identifier data from 308 Communication, 203 imaging Data Receiver transmits the segment identifier data to 202 Work Generator. Segment identifier information could include, but not be limited to, a unique segment identification number, geographic co-ordinates, link and node names. Within 202 Work Generator, the effect of this is to prevent the identified segments from being transmitted to 300 RACU

### 1032 203 Imaging Data Receiver Transmits Data to 204 Data Storage

In the embodiment, 1032 203 Imaging Data Receiver transmits data to 204 Data Storage is the process by which imaging data is placed into storage, flags are placed on the associated segment records to indicate that imaging data has been collected and the date of that collection is recorded.

1032 203 Imaging Data Receiver transmits data to 204 Data Storage contains the following steps:
1032.1 Immediately on receipt of a package of raw imaging data from 308 Communication, 203 Imaging Data Receiver transmits segment identifier information and time and date of imaging data collection to 204 Data Storage. Segment identifier information could include, but not be limited to, a unique segment identification number, geographic co-ordinates, link and node names. Within 204 Data Storage the effect of this is to change the segment record status fields to indicate that imaging data has been collected.

### 1033 204 Data Storage Transmits Data to 205 Client Data Interface

1033 204 Data Storage transmits data to 205 Client Data Interface is the process by which 205 Client Data Interface is advised of the completion of imaging and rating work.

1033 204 Data Storage transmits data to 205 Client Data Interface contains the following steps:
1033.1 204 Data Storage periodically generates a list of segments with completed imaging work and of segments with completed rating work (Completed Data Available list) and transmits these to 205 Client Data Interface.
1033.2 205 Client Data Interface attaches client identifiers to each segment record in the Completed Data Available list to create the Completed Client Data Available list.

### 1034 205 Client Data Interface Transmits Data to 206 Commercial Interface

1034 205 Client Data Interface transmits data to 206 Commercial Interface is the process that conveys the Completed Client Data Available list so that invoices may be issued to clients.

1034 205 Client Data Interface transmits data to 206 Commercial Interface contains the following steps:
1034.1 205 Client Data Interface transmits the Completed Client Data Available list to 206 Commercial Interface.
1034.2 206 Commercial Interface compares the new Completed Client Data Available list with the previous Completed Client Data Available list and generates the Invoice Required list.
1034.3 206 Commercial Interface displays the Invoice Required list to the Operating Organisation by means that include, but are not limited to, electronic and paper.
1034.4 The Operating Organisation reviews the Invoice Required list and enters those approved on 206 Commercial Interface.
1034.5 206 Commercial Interface prints invoices from the approved Invoice Required List,

### 1035 206 Commercial Interface Transmits Data to 205 Client Data Interface

In the embodiment 1035 206 Commercial Interface transmits data to 205 Client Data Interface is the process that conveys the Completed Client Data Accessible list to ensure that access to data is only made available to clients of good commercial standing.

1035 206 Commercial Interface transmits data to 205 Client Data Interface contains the following steps:
1035.1 206 Commercial Interface compares the content of the Completed Client Data Available list with the Client Commercial Standing list. The Client Commercial Standing list is a record of the geographic area of the client's order for data and the payments that have been made by the client. A rule set determines whether the client has access rights and to which parts of the data these rights apply. The result of this comparison is the creation of the Completed Client Data Accessible list.
1035.2 206 Commercial Interface transmits the Completed Client Data Accessible list to 205 Client Data Interface.
1035.3 205 Client Data Interface overwrites the previous Completed Client Data Accessible with the most recent and uses this to determine if client requests to access data are allowable.

### 1036 206 Commercial Interface Transmits Data to 101 Client Imaging Update Demand

In the embodiment 1036 206 Commercial Interface transmits data to 101 Client Imaging Update Demand is the process that advises clients on the Completed Client Data Accessible list of the availability of new data and its identity so that the client may gain access to it.

1036 206 Commercial Interface transmits data to 101 Client Imaging Update Demand contains the following step:
1036.1 206 Commercial Interface communicates to each client on the Completed Client Data Accessible list through whatever method the client has requested. These methods include, but are not limited to, E-mail, SMS, facsimile and letter.
   1037 100 Client Communicates with 205 Client Data Interface

In the embodiment 1037 100 Client communicates with 205 Client Data Interface is the process that enables clients gain access to data ordered by it.

1037 100 Client communicates with 205 Client Data Interface contains the following steps:
1037.1 100 Client logs in to 205 Client Data Interface
1037.2 205 Client Data Interface checks the Completed Client Data Accessible list:
   If the 100 Client is not on the Completed Client Data Accessible list, the log on request is denied.
   If the 100 Client is on the Completed Client Data Accessible list, the log on is allowed.
1037.3 205 Client Data Interface displays to the 100 Client those parts of the Completed Client Data Accessible list that are applicable to the client.

### 1038 205 Client Data Interface Transmits Data to 100 Client

In the embodiment 1038 205 Client Data Interface transmits data to 100 Client is the process that enables clients to obtain the data they have ordered.

1038 205 Client Data Interface transmits data to 100 Client contains the following steps:
1038.1 A 100 Client who has been logged on under 1036.2 selects the data items on the Completed Client Data Accessible list that they wish to view, download or order.
1038.2 The 100 Client chooses from the view, download or order options and submits the request to 205 Client Data Interface,

### 1039 206 Commercial Interface Transmits Data to 502 Rating and Checking

In the embodiment 1039 206 Commercial Interface transmits data to 502 Rating and Checking is the process that determines the remuneration for the organisation(s) providing rating and checking services.

1039 206 Commercial Interface transmits data to 502 Rating and Checking contains the following steps:
1039.1 206 Commercial Interface uses the Completed Data Available list created in 1033.1 to identify QA checked imagery and QA checked rating work.
   1039.2 The Operating Organisation enters into 206 Commercial Interface the identity, contact and remuneration methods of the organisations with whom it contracts for QA checking and Rating work, creating a QA Contract list and a Rating Contract list.
1039.3 206 Commercial Interface uses these two lists and the Completed Data Available list to calculate the remuneration of the 500 Rating contractors and assemble a QA and Rating Remuneration report, which is presented to the Operating Organisation by means that include, but are not limited to, E-mail, ftp, fax and printed document.
1039.4 206 Commercial Interface uses these two lists and the Completed Data Available list to calculate the remuneration of the 300 RACU operators and assembles a Host Vehicle Operator Remuneration report, which is presented to the Operating Organisation by means that include, but are not limited to, E-mail, ftp, fax and printed document.
1039.5 The Operating Organisation reviews the Host Vehicle Operator Remuneration report and enters those approved remuneration into 206 Commercial Interface.
1039.6 206 Commercial Interface prints Request for Invoice statements from the approved Host Vehicle Operator Remuneration report and transmits these to Host Vehicle Operators by suitable means that include, but are not limited to, E-mail, ftp, fax and printed document.

### 1040 502 Rating and Checking Transmits Data to 206 Commercial Interface

In the embodiment 1040 502 Rating and Checking transmits data to 206 Commercial Interface is the process that remunerates the organisation(s) providing rating and checking services.

1040 502 Rating and Checking transmits data to 206 Commercial Interface contains the following steps:
1040.1 QA and Rating Contractors create invoices that reflect the Request for Invoice statements developed in 1038.5 and send these to the Operating Organisation.
1040.2 The Operating Organisation checks the received invoices against the Request for Invoice Statements and enters approved remunerations onto 206 Commercial Interface.
1040.3 206 Commercial Interface, by reference to the QA Contract list and the Rating Contract list, takes action on remuneration by means that include, but are not limited to, electronic funds transfer, printing of cheques and printing of a list of cheques to be drawn.
1040.4 As necessary, the Operating Organisation prints cheques and posts cheques to the QA and Rating contractors.

### 1041 309 Host Vehicle Operator Transmits Data to 206 Commercial Interface

In the embodiment 1041 309 Host Vehicle Operator transmits data to 206 Commercial Interface is the process that remunerates the operator of 300 RACU.

1041 309 Host Vehicle Operator transmits data to 206 Commercial Interface contains the following steps:
1041.1 309 Host Vehicle Operator creates an invoice that reflects the Request for Invoice statements developed in 1036.5 and send it to the Operating Organisation by suitable means that include, but are not limited to, E-mail, ftp, fax and printed document.
1041.2 The Operating Organisation checks the received invoices against the Request for Invoice Statements and enters approved remunerations onto 206 Commercial Interface.
1041.3 206 Commercial Interface, by reference to the RACU Contract list, takes action on remuneration by means that include, but are not limited to, electronic funds transfer, printing of cheques and printing of a list of cheques to be drawn.
1041.4 As necessary, the Operating Organisation prints cheques and posts cheques to the Host Vehicle Operator.

### Example 1

### One RACU Operator

| Operating Unit | |
|---|---|
| Components | Description |
| 300 RACU | It is 7.30am on Saturday the 16^{th} February, 2008 and Brian Jones |
| 304 Current | (a Jim's Antennas franchisee) is preparing to do a morning's work |
| Position and | to clear the job list for the week. It is his birthday and he is looking |
| Movement Vector | forward to taking his family out to dinner in the evening. As a |
| 305 Data | franchisee, Brian receives TV antenna installation and trouble- |
| Collection System | shooting jobs through the Jim's Network and spends his day |
| 308 | driving from one job to the next, covering mainly the Eastern |
| Communication | Suburbs of Melbourne. Other franchisees cover the Northern |
| System | Southern and Western suburbs and the inner city areas too. He |
| 400 Host Vehicle | knows many of them from the franchisee meetings that are held |
| Interface | periodically. Brian is one of the franchisees who has a 300 RACU |
| 402 Navigation | and 400 Host Vehicle Interface installed on his van. The imaging |
| Display | (305 Data Collection System), navigation (304 Current Position |
| 404 Status Display | and Movement Vector) and communication (308 Communication |
| | System) modules of the 300 RACU are mounted on a roof rack |
| | and there is a module in the cabin of the van (400 Host Vehicle |
| | Interface) that includes a navigation unit (402 Navigation Display), |
| | and he finds this handy for navigating to places he has not been to |
| | before. The cabin module (400 Host Vehicle Interface) sits on his |
| | dashboard, with features (404 Status Display) that help him to |
| | keep in touch with what the roof-mounted modules are doing. The |
| | 300 RACU has become an important component in keeping |
| | Melbourne on the world map, as the imaging it does has become a |
| | regular part of modern life and make it possible for people from all |
| | over the world to see the streetscapes they are about to visit, or |
| | where their family and friends live, without actually visiting. |
| | Streetscape imaging has become an essential part of the web |
| | presence of all big cities over the last couple of years, and Brian is |
| | proud to be one of the image collectors, as well as happy with the |
| | extra money he is able to make simply by driving from one |
| | customer to the next. This has built up to the point where it has |
| | become possible for him to buy an investment house and to enjoy |
| | being able to celebrate special occasions with his family, like |
| | tonight's dinner. |
| 300 RACU | Saying goodbye to his wife and children, Brian goes out to the |
| 308 | carport where his van is parked. He has wired the carport up with |
| Communication | a network cable, and he attached this to the 300 RACU (308 |
| System | Communication System) the previous evening on arriving home, to |
| 200 Server | allow the 300 RACU to upload the imaging taken the previous day |
| 203 Imaging Data | to the 200 Server via the 203 Imaging Data Receiver. He glances |
| Receiver | in the window at the 404 Status Display and is pleased to see the |
| | steady amber light that indicates that transmission of the previous |
| | day's data has been completed. He disconnects the network |
| | cable, cleans the transparent covers over the camera lenses and |
| | gets into the van. |
| 200 Server | Turning on his mobile phone, he is a little annoyed to see another |
| 202 Work | Jim's Antennas job has been SMS'd in to him and hopes this does |
| Generator | not mean he is going to be working all day. This new job is quite |
| 300 RACU | close to the one that he knows of, both in new housing estates |
| 302 Operational | with numerous twisty courts and dead ends. He is glad of the |
| Status | navigation features accessible through the 402 Navigation Display |
| 308 | as it makes finding his way into these new areas quicker and safer |
| Communication | too, as he does not have to glance at his Melways Street Directory |
| System | all the time. He loads the two addresses into the 402 Navigation |
| 402 Navigation | Display, using the touch screen. The 402 Navigation Display |
| Display | changes to display his route and he notices the blue flashing light |
| 404 Status | (404 Status Display) telling him that the 300 RACU is performing |
| Display | its system check (302 Operational Status) change to a steady blue |
| | glow - the system is on standby and ready to collect imaging as |
| | he drives. Had he looked, he would next have seen the white |
| | flashing status light (404 Status Display), indicating the 300 RACU |
| | was receiving data from the server (308 Communication System). |
| | This would be an updated route segment listing (from 202 Work |
| | Generator, via 308 Communication) for streets in need of image |
| | within a radius of 5 km of his present position. A glance at the sky |
| | tells Brian this is going to be a good morning for collecting |
| | imaging. The weather is fine and there is a high overcast, so there |
| | is a steady and uniform illumination. |
| 300 RACU | Driving out from his driveway, he is a little surprised to see a |
| 301 Auto | nearby street, Flash Avenue, highlighted in orange on the 402 |
| Collection | Navigation Display, indicating that a special order has been placed |
| Governor | for imaging to be updated in that street. He last drove Flash |
| 400 Host Vehicle | Avenue two months ago and was not expecting to do so again at |
| Interface | least for another three months. The orange highlight indicates a |
| 402 Navigation | special order has been placed, worth about $100. It seems like a |
| Display | birthday present! A minor detour from his direct street onto the |
| 404 Status Display | highway will get him there and he checks the status lights on the |
| | 404 Status Display - still a steady blue. As he gets closer to the |
| | start of Flash Avenue, he notes the 404 Status Display is now |
| | flashing green, indicating that it is getting ready to collect imaging. |
| | As he enters Flash Avenue, this changes to a steady green and |
| | remains so for the length of the Avenue, reverting briefly back to |
| | flashing green as he reaches the end and then shows the steady |
| | blue of standby again, Turning round, he approaches from the |
| | other direction and collects imaging of the other side of Flash |
| | Avenue. Good - that only took five minutes and he imagines the |
| | one hundred dollar bill flying into his bank account, as the flashing |
| | yellow status light on 404 Status Display, showing him the data is |
| | being checked by 301 Auto Collection Governor, changes to |
| | steady blue again. |
| 400 Host Vehicle | Back on the highway, he knows how to get to the new estate and |
| Interface | so ignores the soft voice of the navigation computer (401 Map |
| 401 Map CPU | CPU). An occasional glance at the route display of 402 Navigation |
| 402 Navigation | Display shows him a number of streets off the highway that are |
| Display | highlighted in yellow. He will need to drive them soon as their |
| | imaging will need updating within 30 days. Nearing the new |
| | estate, he starts to listen to the soft voice's directions and drives |
| | through the grand entrance with its fluttering display flags. He is |
| | not surprised to see numerous streets highlighted yellow on the |
| | 402 Navigation Display, but notes with satisfaction that those that |
| | he drove on his last visit here are no longer highlighted - good, |
| | that means the imaging was successful and the money is as good |
| | as in the bank! For now, it is time to do the antenna job and he |
| | ignores them. The soft voice guides him through the curly routes, |
| | and it is just as well he did not have his head in the Melways as he |
| | has to brake sharply to avoid a dog chasing a ball. |
| 200 Server | The antenna installation job goes smoothly and soon he is back in |
| 202 Work | the van. He notices that the 404 Status Display is indicating |
| Generator | steady amber again, obviously it had such a good mobile signal |
| 300 RACU | that 308 Communication System has been able to transmit all the |
| 308 | Flash Avenue data to the 200 Server already. What he did not |
| Communication | see when he was in doing the job, was the white flashing light as |
| System | the 300 RACU received another update of route segments (from |
| 400 Host Vehicle | 202 Work Generator via 308 Communication System) needing |
| Interface | image collection in his current area. Now Brian needs to know |
| 402 Navigation | how to get to this new job he received on the SMS earlier and so |
| Display | he follows the directions of the soft voice all the way there. En |
| 404 Status Display | route he notices the status light of 404 Status Display occasionally |
| | flashing green (ready to start imaging) as he drives past a few |
| | yellow highlighted (on 402 Navigation Display) streets and courts, |
| | but he is not turning in to them and the status light reverts to blue |
| | each time he passes. He notes that there is quite a bit of |
| | collection he could do out here. He is not surprised to see that the |
| | next job is in a street that needs imaging and notes the 300 RACU |
| | start collecting for all of the last 2 km or so in to the job. As he |
| | follows the voice prompts to get to the destination a glance at the |
| | 402 Navigation Display shows him that all the local streets need |
| | imaging. |
| 300 RACU | After that job is completed, Brian sits in the van and pours a cup of |
| 301 AutoCollection | tea from his thermos and considers what to do. The 308 |
| Governor | Communication System has finished transmitting the last lot of |
| 308 | data, the lighting conditions are still good. He calls his wife, who |
| Communication | tells him she is about to leave with the children for the shops and |
| System | will be home in about an hour. With a twenty-minute drive home, |
| 400 Host Vehicle | that means he could spend forty minutes collecting money, er, he |
| Interface | means, imaging and be home at the same time. The decision |
| 402 Navigation | made, he starts the van. A frown crosses his brow as he sees the |
| Display | red light on the 404 Status Display flashing, something has gone |
| 404 Status Display | wrong and the 300 RACU is attempting to repair itself (301 |
| | AutoCollection Governor)! Within a minute, the red flashing is |
| | replaced by a reassuring steady blue light; the system is on |
| | standby and ready to collect. Seeing that all the nearby streets |
| | need collecting, he chooses a suitable route and drives the |
| | suburb, watching the 404 Status Display change from green |
| | flashing to steady green and back again as he completes the |
| | streets. In 40 minutes he has managed to collect a large |
| | proportion of the available streets. Not too sure how to get home |
| | quickly, he inserts home as his destination in the 402 Navigation |
| | Display and drives home following the soft voice directions. As he |
| | drives, the 404 Status Display flashes yellow as it checks the |
| | collected data and then changes to flashing amber as it transmits |
| | the data. |
| 200 Server | By the time Brian arrives home, the 404 Status Display is showing |
| 203 Imaging Data | an intermittent amber light, indicting that data transmission has not |
| Receiver | been completed. He turns off the engine, gets out and plugs in the |
| 300 RACU | network cable again, confident in the knowledge that as he enjoys |
| 308 | his day, the 300 RACU will be sending data back (via 308 |
| Communication | Communication System and 203 Imaging Data Receiver) to the |
| System | PureData server through his computer. He estimates that today's |
| 400 Host Vehicle | driving has resulted in an extra $150 of income, as he looks |
| Interface | forward to the evening's celebrations. |
| 404 Status Display | |

As would be apparent the colour codes and signals referred to above are examples only. Other methods of display include, but are not limited to icons, text and synthesised voice.

### Example 2

### Two RACU Operators

| Operating Unit | |
|---|---|
| Components | Description |
| 300 RACU | One of Brian's fellow franchisees is Kevin Richardson. Kevin lives |
| 400 Host Vehicle | less than five kilometres from Brian and generally looks after |
| Interface | customers to the North of Brian, but naturally, there is an overlap |
| 402 Navigation | at times as they do work close to the boundaries of each other's |
| Display | area. Kevin's vehicle also has a 300 RACU and 400 Host Vehicle |
| 404 Status Display | Interface attached to it. |
| | One morning, each of them has their first antenna installation job |
| | of the day in the same suburb, actually about three kilometres |
| | apart. Driving to their first jobs, neither of them thinks about |
| | collecting imaging en route; their assessment of the lighting |
| | conditions is the same as the 300 RACU, obviously, as the status |
| | light (shown on 404 Status Display) is flashing red at them. It is |
| | one of those Melbourne winter mornings with low cloud and it is |
| | gloomy at 7.30am. When Kevin finishes his job, however, the sun |
| | is higher and the cloud has started to break up, so that as he |
| | starts his van he notices the 404 Status Display status light is |
| | indicating a steady blue - ready to collect. He looks at the 402 |
| | Navigation Display and notices two streets nearby and to the |
| | South that are highlighted in yellow as in need of collection. His |
| | next job is an appointment in one hour's time and there is no point |
| | getting there early as the house owner will not be at home before |
| | then. He decides to drive the short distance to these two streets |
| | and collect imaging. |
| 200 Server | Brian's first job was very close to these two streets, but he gets |
| 202 Work | back in his van when Kevin is already approaching the streets, as |
| Generator | his job took a little longer. His next job takes him further South |
| 300 RACU | into his area, but these two streets in need of collection are so |
| 308 | close he is tempted to drive them before heading for the next job. |
| Communication | As he drives, the 404 Status Display data transmission status light |
| System | is periodically flashing white as it receives a route segment data |
| 402 Navigation | update from the 200 Server (via 202 Work Generator and 308 |
| display | Communication System). When it is not, his amber transmission |
| 404 Status Display | light (404 Status Display) flashes tell him his 300 RACU is |
| 200 Server | communicating its position to the 200 Server very regularly. He |
| 203 Imaging Data | knows that the more frequent than usual updates mean that |
| Receiver | another 300 Host Vehicle Operator is operating in this area too. |
| | He guesses that this is Kevin and a (hands free) phone call |
| | confirms the fact. On the phone they agree to take one street |
| | each. Kevin is actually half way through collecting his street, so |
| | that a few minutes later Brian notices the yellow highlight of that |
| | street on his 402 NavigationDisplay disappear as Kevin's 300 |
| | RACU communicates its completion of the street to the 200 |
| | Server. |
| 300 RACU | Brian's expectation of another 300 RACU operating in the same |
| 400 Host Vehicle | area would also have been confirmed as Kevin started collecting, |
| Interface | as the yellow highlight of the street Kevin was collecting would |
| 402 Navigation | have been flashing on Brian's 402 Navigation Display. Brian |
| Display | could, in principle, have driven to the route and watched to see |
| | whose 300 RACU it was. Alternatively he could have driven to the |
| | second of the streets and started collecting that one. With a short |
| | delay only, Kevin's 402 Navigation Display would have shown that |
| | street flashing yellow and he would have known someone else |
| | was in the area also collecting. |

It is to be appreciated that the present invention encompasses a wide variety of applications including the collection and use of images of building fronts for say town planners in local governments.

The embodiment addresses the problem of limited access to imaging data given that the job of developing a database of asset condition for say local or state governments is typically led by competitive tender. This process limits the accessibility of the imaging data that is collected to other potential users, such as but not limited to real estate agencies, city and telephone directories, providers of information over the internet (for example Google Earth and Amazon A9). The benefits of the arrangements described above include the sharing of costs amongst multiple users, thereby enabling more users to be attracted and the ability of the Operating Organisation to charge for images on a subscription basis, leading to a more sustainable business process.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

For example a list of possible uses for the imagery include: asset inventory, safety surveys; sight distances; GIS auditing; condition surveys (trees, footpaths, kerbs, crossings, lines, signs, pavement items); maintenance contract audits; route sign verification; bus route determination; vegetation control; public complaint investigation; project planning.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

It should be noted that where the terms “server”, “secure server” or similar terms are used herein, a communication device is described that may be used in a communication system, unless the context otherwise requires, and should not be construed to limit the present invention to any particular communication device type. Thus, a communication device may include, without limitation, a bridge, router, bridge-router (router), switch, node, or other communication device, which may or may not be secure.

It should also be noted that where a flowchart is used herein to demonstrate various aspects of the invention, it should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Various embodiments of the invention may be embodied in many different forms, including computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an exemplary embodiment of the present invention, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g, a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

As with “includes/including”, “comprises/comprising” when used in this specification is taken to specify the presence of stated features, integers, steps or components but does not preclude the presence or addition of one or more other features, integers, steps, components or groups thereof.” Thus, unless the context clearly requires otherwise, throughout the description and the claims, the words ‘comprise’, ‘comprising’, and the like are to be construed in an inclusive sense as opposed to an exclusive or exhaustive sense; that is to say, in the sense of “comprising, that is not limited to”.

1-32. (canceled)

33. A method for collecting data, comprising the steps of:
equipping vehicles in a fleet of vehicles, performing a primary service, with imaging equipment; and,
capturing geographical data via the imaging equipment for later use in a store of geographical data.

34. The method for collecting data according to claim 33, wherein the geographical data includes asset information associated with road assets distributed over a road network.

35. The method for collecting data according to claim 33, further comprising the step of determining route segments for which imaging is desired.

36. The method for collecting data according to claim 35, wherein said step of determining route segments for which imaging is desired includes applying time-based criteria.

37. The method for collecting data according to claim 35, further comprising the step of providing route segment data containing route node location and segment length information.

38. The method for collecting data according to claim 35, wherein the route segment data includes at least one selected datum from the group of shortest route from current position to destination; quickest route from current position to destination; longer route from current position to destination offering higher value segments; and an even longer route from current position to destination offering even higher value segments.

39. The method for collecting data according to claim 33, further comprising the step of informing one or more vehicles in the fleet of vehicles of a particular vehicle capturing geographical data in a vicinity of the more or more vehicles in the fleet of vehicles.

40. The method for collecting data according to claim 33, further comprising the step of transmitting the geographical data captured by the fleet of vehicles to a remote location.

41. The method for collecting data according to claim 33, further comprising the step of determining route choices for at least one vehicle of the fleet of vehicles.

42. The method for collecting data according to claim 33, further comprising the step of sending the geographical data from each vehicle of the fleet of vehicles to an operating organization which derives a profit from the geographical data.

43. A system for collecting data, comprising:
a transmission facility for transmitting network information to a plurality of vehicles in a fleet of vehicles performing a primary service; and,
means for capturing geographical data via said network information.

44. The system for collecting data according to claim 43, further comprising:
a facility for receiving said geographical data; and,
means for confirming that said geographical data is associated with said network information stored by a data store forming part of said system.

45. A computer program product, comprising:
a computer usable medium having a computer readable program code and a computer readable system code embodied on said computer usable medium for data communication using a data processing system, said data communication being performed via a method for collecting data, comprising the steps of:
equipping vehicles in a fleet of vehicles, performing a primary service, with imaging equipment; and,
capturing geographical data via the imaging equipment for later use in a store of geographical data; and,
said computer program product further comprising:
a computer readable code within said computer usable medium.
